(19) United States
(12) Patent Application Publication
(10) Pub. No.: US 2025/0133578 A1
(43) Pub. Date: Apr. 24, 2025

(54) HANDLING MULTICAST COMMUNICATIONS

(71) Applicant: Telefonaktiebolaget LM Ericsson (publ), Stockholm (SE)

(72) Inventors: Dung PHAM VAN, UPPLANDS VÄSBY (SE); Erik STARE, SOLLENTUNA (SE)

(73) Assignee: Telefonaktiebolaget LM Ericsson (publ), Stockholm (SE)

(21) Appl. No.: 18/834,633

(22) PCT Filed: Feb. 17, 2023
(86) PCT No.: PCT/EP2023/054034

§ 371 Date: Jul. 31, 2024

Related U.S. Application Data
(60) Provisional application No. 63/311,646, filed on Feb. 18, 2022.

(51) Int. Cl. H04W 72/30

(52) U.S. Cl. CPC H04W 72/30

(57) ABSTRACT

There is provided a method of operating a communication device of a communications network. The method comprises receiving (300) a first signal from a network node of the communications network, determining (302) a communication parameter from the first signal, and receiving (304) multicast radio bearer (MRB) communications from the network node using the communication parameter.

### TECHNICAL FIELD

The present disclosure is related to communication systems and more particularly to handling multicast communications.

### BACKGROUND

FIG. 1 illustrates an example of a new radio (“NR”) network (e.g., a 5th Generation (“5G”) network) including a 5G core (“5GC”) network 130, network nodes 120a and 102b (e.g., 5G base station (“gNB”)), and multiple communication devices 110 (also referred to as user equipment (“UE”)).

NR Multicast and Broadcast Services (“NR_MBS”) work item objectives are described below.

In 3^{rd} Generation Partnership Project (“3GPP”) Release 17, operations for NR_MBS are being specified. Radio access network (“RAN”) basic functions are specified for broadcast/multicast for UEs in a radio resource control connected (RRC_CONNECTED) state [RAN1, RAN2, RAN3]. In some examples, a group scheduling mechanism allows UEs to receive a Broadcast/Multicast service [RAN1, RAN2]. This objective includes specifying necessary enhancements that are required to enable simultaneous operation with unicast reception. In additional or alternative examples, support for the dynamic change of a Broadcast/Multicast service delivery between multicast (also referred to as point-to-multipoint (“PTM”)) and unicast (also referred to as point-to-point (“PTP”)) with service continuity for a given UE [RAN2, RAN3] are specified. In additional or alternative examples, support for basic mobility with service continuity [RAN2, RAN3] is specified. In additional or alternative examples, assuming that the necessary coordination function (like functions hosted by multicast coordination entity (“MCE”), if any) resides in the gNB-centralized unit (“gNB-CU”), required changes on the RAN architecture and interfaces are specified, considering the results of the System Aspects Working Group 2 (“SA2”) system information (“SI”) on Broadcast/Multicast (SP-190625) [RAN3]. In additional or alternative examples, required changes to improve the reliability of Broadcast/Multicast service are specified (e.g., by uplink (“UL”) feedback). The level of reliability can be based on the requirements of the application/service provided [RAN1, RAN2]. In additional or alternative examples, the support for dynamic control of the Broadcast/Multicast transmission area within one gNB distributed unit (gNB-DU) can be studied and it can be specified what is needed to enable it, if anything [RAN2, RAN3].

RAN basic functions for broadcast/multicast for UEs in RRC idle/RRC inactive (RRC_IDLE/RRC_INACTIVE) states [RAN2, RAN1] are also being specified. For example, required changes are specified to enable the reception of Point to Multipoint transmissions by UEs in RRC_IDLE/RRC_INACTIVE states, with the aim of keeping maximum commonality between RRC_CONNECTED state and RRC_IDLE/RRC_INACTIVE state for the configuration of PTM reception [RAN2, RAN1]. The possibility of receiving Point to Multipoint transmissions by UEs in RRC_IDLE/RRC_INACTIVE states, without the need for those UEs to get the configuration of the PTM bearer carrying the Broadcast/Multicast service while in RRC_CONNECTED state beforehand, is subject to verification of service subscription and authorization assumptions during the work item (“WI”).

Due to the time consideration, support for reception of multicast services by UEs in RRC_IDLE/RRC_INACTIVE states is not discussed in Release 17. Instead, reception of multicast services in RRC_INACTIVE becomes a part of Release 18 work item on NR_MBS.

In Release 17, procedures are developed for the support of multicast in RRC_CONNECTED state, while broadcast is supported in all RRC states.

With the Release 17 SA2 System Architecture for Multicast and Broadcast Services (“MBS”), there are two modes of operation, which both target delivery of internet protocol (“IP”) multicast data to groups of UEs. The two modes of operation are the multicast mode (UE needs to join MBS session) and the broadcast mode.

The RAN provides the functionality to provide IP multicast data from the 5GC using the SA2 multicast mode or the broadcast mode to UEs. When the SA2 multicast mode is used, RAN multicast is used. When the SA2 broadcast mode is used, RAN broadcast is always used.

For both RAN multicast and RAN broadcast, the RAN uses the new concept of a Multicast Radio Bearer (“MRB”) to deliver the IP multicast data to the UEs. With SA2 multicast, each service identifier (e.g., temporary mobile group identity (“TMGI”)) is mapped to an MBS session, which is mapped to one or more MRBs in the RAN. Each Quality-of-Service (“QoS”) flow of the MBS session is mapped to one MRB. If RAN multicast and broadcast are used at the same time from a gNB, they will use logically different MRBs.

FIG. 2 illustrates an example in which a UE can be configured with a PTM-only MRB, a PTP-only MRB or a split-MRB, which has a “PTM leg” and a “PTP leg”. The protocol stacks of the PTM-only and PTP-only MRBs are identical to the respective PTM and PTP legs of the split-MRB. Broadcast uses the PTM-only MRB, although without hybrid automatic repeat request (HARQ) feedback.

As can be seen from FIG. 2, the two legs of the split-MRB have a common packet data control protocol (“PDCP”) layer, which is typically hosted in the gNB-CU. The lower layers are typically hosted in the gNB-DU and it is the distributed unit (“DU”) that decides on which leg to use for a particular IP multicast packet to transmit. At radio link control (“RLC”) layer, the PTP leg supports the RLC Acknowledged Mode (“RLC-AM”) from legacy NR, which means that the RLC-AM entity in the UE can be configured to send a negative acknowledgement (“NACK”) to the RLC-AM entity in the gNB in case of an incorrectly received RLC packet, which may trigger a retransmission of the RLC protocol data unit (“PDU”), with a corresponding increase in reliability. In the PTM leg the RLC Unacknowledged Mode (“RLC-UM”) is used, i.e., without such retransmission.

However, there currently exist some challenges and there is a need for an improved technique for handling multicast communications.

### SUMMARY

It is an object of the disclosure to obviate or eliminate at least some of the challenges and thereby provide an improved technique for handling multicast communications.

Therefore, according to an aspect of the disclosure, there is provided a first method operating a communication device of a communications network. The first method comprises receiving a first signal from a network node of the communications network, determining a communication parameter from the first signal, and receiving multicast radio bearer (MRB) communications from the network node using the communication parameter.

According to another aspect of the disclosure, there is provided a second method of operating a communication device of a communications network. The second method comprises transitioning from a first state in which the communication device is configured to communicate with a network node of the communications network via a first MRB to a second state in which the communication device is configured to communicate with the network node via a second MRB that is different than the first MRB. The second method also comprises determining a second communication parameter associated with communicating with the network node via the second MRB based on a first communication parameter associated with communicating with the network node via the first MRB.

According to another aspect of the disclosure, there is provided a third method of operating a network node of a communications network. The third method comprises transmitting a first signal to the communication device indicating a communication parameter and transmitting MRB communications to the communication device using the communication parameter.

According to another aspect of the disclosure, there is provided a fourth method of operating a network node of a communications network. The fourth method comprises, responsive to a communication device transitioning from a first state in which the communication device is configured to communicate with a network node of the communications network via a first MRB to a second state in which the communication device is configured to communicate with the network node via a second MRB that is different than the first MRB, determining a second communication parameter associated with the second MRB based on a first communication parameter associated with the first MRB. The fourth method also comprises communicating with the communication device via the second MRB using the second communication parameter.

According to another aspect of the disclosure, there is provided a method performed by a communications network, wherein the method comprises any two or more of the first method, second method, third method, and fourth method.

According to another aspect of the disclosure, there is provided a communication device operating in a communications network. The communication device comprises processing circuitry and a memory. The memory is coupled to the processing circuitry and has instructions stored therein that are executable by the processing circuitry to cause the communication device to perform operations comprising any of the operations of the first method and/or the second method.

According to another aspect of the disclosure, there is provided a network node operating in a communications network. The network node comprises processing circuitry and a memory. The memory is coupled to the processing circuitry and has instructions stored therein that are executable by the processing circuitry to cause the network node to perform operations comprising any of the operations of the third method and/or the fourth method.

According to another aspect of the disclosure, there is provided a communications network comprising the communication device and the network node.

According to another aspect of the disclosure, there is provided a computer program comprising program code to be executed by processing circuitry, whereby execution of the program code causes the processing circuitry to perform operations comprising any operations of any of the first method, the second method, the third method, and/or the fourth method.

According to another aspect of the disclosure, there is provided a computer program product comprising a non-transitory storage medium including program code to be executed by processing circuitry, whereby execution of the program code causes the processing circuitry to perform operations comprising any operations of any of the first method, the second method, the third method, and/or the fourth method.

According to another aspect of the disclosure, there is provided a non-transitory computer-readable medium having instructions stored therein that are executable by processing circuitry to cause the processing circuitry to perform operations comprising any of the operations of the first method, the second method, the third method, and/or the fourth method.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of a split-multicast radio bearer (“MRB”);

FIGS. 3-4 are flow charts illustrating examples of operations performed by a communication device in accordance with some embodiments;

FIGS. 5-6 are flow charts illustrating examples of operations performed by a network node in accordance with some embodiments;

FIG. 7 is a diagram illustrating an example of operations for handling a multicast radio bearer in response to changes in a state of a communication device in accordance with some embodiments

FIG. 8 is a signal flow diagram illustrating an example of operations for handling resumption of new radio (“NR”) multicast service reception in accordance with some embodiments;

FIGS. 9-10 are flow charts illustrating examples of operations performed by a communication device in accordance with some embodiments;

FIGS. 11-12 are flow charts illustrating examples of operations performed by a network node in accordance with some embodiments;

FIG. 13 is a block diagram of a communication system in accordance with some embodiments;

FIG. 14 is a block diagram of a user equipment in accordance with some embodiments

FIG. 15 is a block diagram of a network node in accordance with some embodiments;

FIG. 16 is a block diagram of a host computer communicating with a user equipment in accordance with some embodiments;

FIG. 17 is a block diagram of a virtualization environment in accordance with some embodiments; and

FIG. 18 is a block diagram of a host computer communicating via a base station with a user equipment over a partially wireless connection in accordance with some embodiments in accordance with some embodiments.

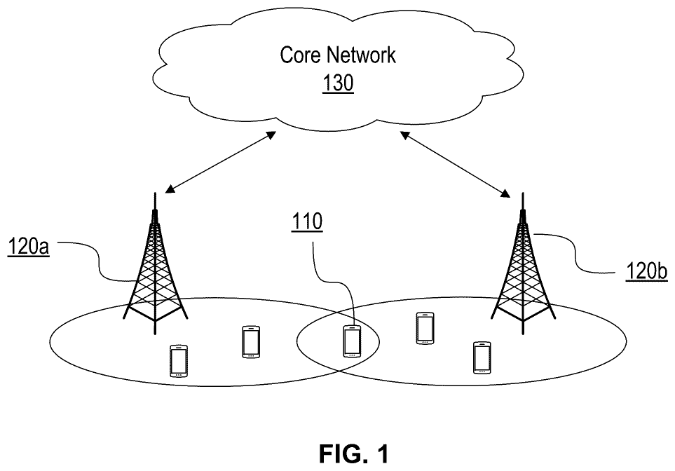

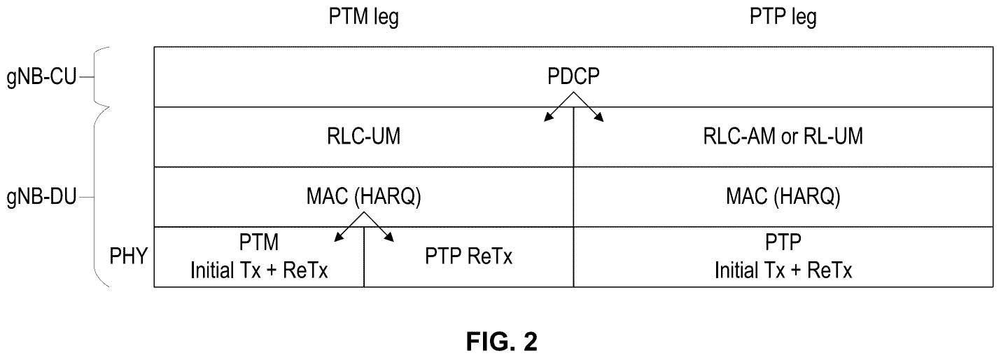

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The present disclosure relates to handling multicast communications and, more specifically, to the resumption of (e.g. radio or new radio) multicast service reception. The present disclosure also relates to calculating communication device mobility state using reference frequency.

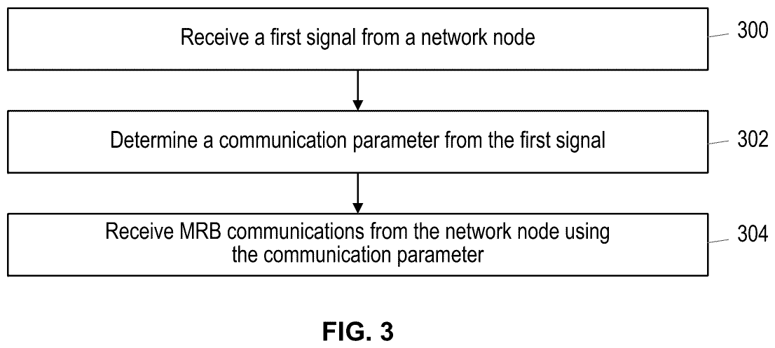

FIG. 3 illustrates a first method operating a communication device of a communications network in accordance with some embodiments. At block 300, the first method comprises receiving a first signal from a network node of the communications network. At block 302, the first method comprises determining a communication parameter from the first signal. At block 304, the first method comprises receiving multicast radio bearer (MRB) communications from the network node using the communication parameter.

In some embodiments, receiving the first signal may comprise receiving a first packet data convergence protocol (PDCP) protocol data unit (PDU) from the network node. In some embodiments, receiving the first signal may comprise receiving the first signal prior to receiving a first PDCP PDU from the network node. In some embodiments, receiving the first signal may further comprise receiving the first signal as part of a procedure performed to transition the communication device from an inactive state to a connected state.

In some embodiments, determining the communication parameter may comprise determining an expected sequence number associated with the MRB communications, and receiving the MRB communications may comprise receiving the first PDCP PDU from the network node. In some of these embodiments, the first method may further comprise determining whether the communication device failed to receive a second PDCP PDU from the network node by comparing a sequence number associated with the first PDCP PDU and the expected sequence number.

In some embodiments, the first method may comprise transitioning from an inactive state to a connected state.

In some embodiments, the MRB communications may be second MRB communications, the connected state may be a second instance of the connected state, and the first method may further comprise receiving first MRB communications from the network node while the communication device is in a first instance of the connected state and, subsequent to receiving the first MRB communications, transitioning from the first instance of the connected state to the inactive state.

In some embodiments, transitioning from the first instance of the connected state to the inactive state may comprise initializing the communication parameter to a predetermined value or avoiding initialization of the communication parameter.

In some embodiments, the inactive state may comprise a radio resource control (RRC) inactive state, the connected state may comprise an RRC connected state, and the MRB communications may comprise at least one of: multicast MRB communications and broadcast MRB communications.

In some embodiments, the communication parameter may comprise a PDCP state variable, for example, including at least one of: a first RX NEXT variable and a first RX DELIV variable.

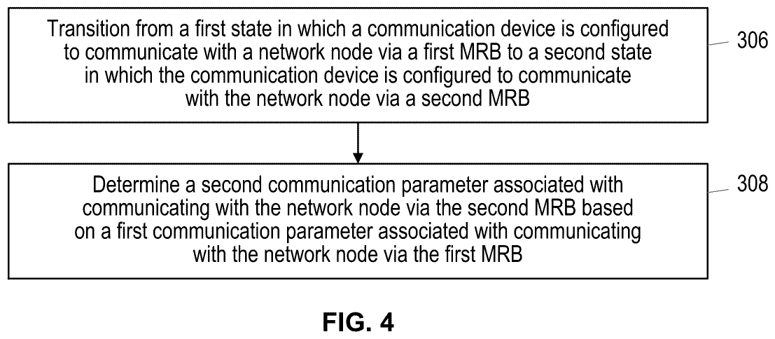

FIG. 4 illustrates a second method of operating a communication device of a communications network in accordance with some embodiments. At block 306, the second method comprises transitioning from a first state in which the communication device is configured to communicate with a network node of the communications network via a MRB to a second state in which the communication device is configured to communicate with the network node via a second MRB that is different than the first MRB. At block 308, the second method comprises determining a second communication parameter associated with communicating with the network node via the second MRB based on a first communication parameter associated with communicating with the network node via the first MRB.

In some embodiments, the first state may comprise an RRC connected state, the first MRB may comprise a multicast MRB, the second state may comprise an RRC inactive state, and the second MRB may comprise a broadcast MRB. In some embodiments, the first state may comprise an RRC inactive state, the first MRB may comprise a broadcast MRB, the second state may comprise an RRC connected state, and the second MRB may comprise a multicast MRB.

In some embodiments, determining the second communication parameters may comprise determining a first sequence number associated with the first MRB and determining a second sequence number associated with the second MRB based on the first sequence number. In some embodiments, determining the second sequence number may comprise determining that the network node synchronized the first sequence number and the second sequence number and determining that the second sequence number is equal to the first sequence number.

In some embodiments, determining the second communication parameters may comprise receiving an indication from the network node of a relationship between the first communication parameter and the second communication parameter. In some embodiments, receiving the indication may comprise receiving an indication that the network node synchronized the first sequence number and the second sequence number.

In some embodiments, determining the second communication parameter may comprise determining the second communication parameter based on the first communication parameter in response to receiving the indication from the network node of the relationship between the first communication parameter and the second communication parameter.

In some embodiments, the first communication parameter may comprise a first PDCP state variable, for example, including at least one of: a first RX_NEXT variable and a first RX_DELIV variable. In some embodiments, the second communication parameter may comprise a second PDCP state variable, for example, including at least one of: a second RX_NEXT variable and a second RX_DELIV variable.

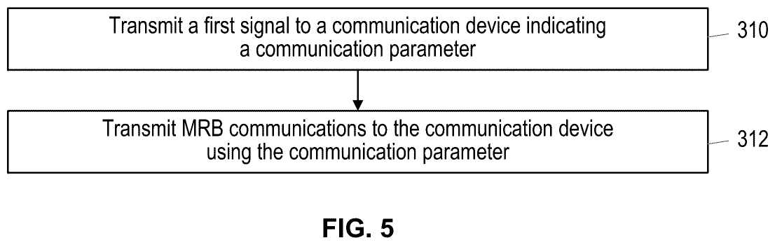

FIG. 5 illustrates a third method of operating a network node of a communications network in accordance with some embodiments. At block 310, the third method comprises transmitting a first signal to the communication device indicating a communication parameter. At block 312, the third method comprises transmitting MRB communications to the communication device using the communication parameter.

In some embodiments, transmitting the first signal may comprise transmitting a first PDCP PDU to the communication device. In some embodiments, transmitting the first signal may comprise transmitting the first signal prior to transmitting a first PDCP PDU to the communication device. In some embodiments, transmitting the first signal may further comprise transmitting the first signal as part of a procedure performed to transition the communication device from the inactive state to the connected state.

In some embodiments, the communication parameter may comprise an expected sequence number associated with the MRB communications and transmitting the MRB communications may comprise transmitting the first PDCP PDU to the communication device using the expected sequence number.

In some embodiments, transmitting the first signal to the communication device may be performed responsive to the communication device transitioning from the inactive state to a second instance of the connected state.

In some embodiments, the MRB communications may be third MRB communications and the connected state may be a second instance of the connected state. In some of these embodiments, the third method may further comprise transmitting first MRB communications to the communication device while the communication device is in a first instance of the connected state and transmitting second MRB communications to other devices while the communication device is in the inactive state.

In some embodiments, the inactive state may comprise an RRC inactive state, the connected state may comprise an RRC connected state, and the MRB communications may comprise at least one of: multicast MRB communications and broadcast MRB communications.

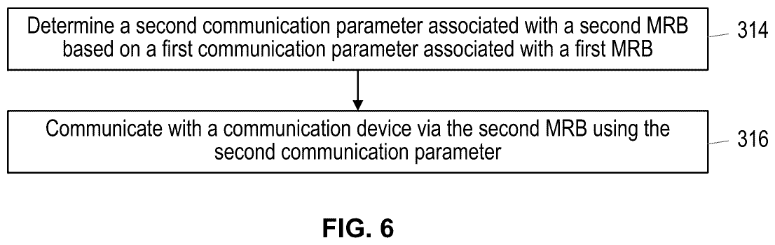

FIG. 6 illustrates a fourth method of operating a network node of a communications network in accordance with some embodiments. At block 314, the fourth method comprises, responsive to a communication device transitioning from a first state in which the communication device is configured to communicate with a network node of the communications network via a first MRB to a second state in which the communication device is configured to communicate with the network node via a second MRB that is different than the first MRB, determining a second communication parameter associated with the second MRB based on a first communication parameter associated with the first MRB. At block 316, the fourth method comprises communicating with the communication device via the second MRB using the second communication parameter.

In some embodiments, the first state may comprise an RRC connected state, the first MRB may comprise a multicast MRB, the second state may comprise an RRC inactive state, and the second MRB may comprise a broadcast MRB. In some embodiments, the first state may comprise an RRC inactive state, the first MRB may comprise a broadcast MRB, the second state may comprise an RRC connected state, and the second MRB may comprise a multicast MRB.

In some embodiments, the first communication parameter may comprise a first sequence number. In some embodiments, the second communication parameter may comprise a second sequence number.

In some embodiments, determining the second communication parameter may comprise synchronizing the second communication parameter with the first communication parameter.

In some embodiments, the fourth method may further comprise transmitting an indication of a relationship between the second communication parameter and the first communication parameter to the communication device.

In some embodiments, the fourth method may further comprise, prior to the communication device transitioning from the first state to the second state, communicating with the communication device via the first MRB using the first communication parameter.

There is also provided a method performed by a communications network, wherein the method comprises any two or more of the first method, second method, third method, and fourth method.

There is also provided a communication device operating in a communications network. The communication device comprises processing circuitry and a memory. The memory is coupled to the processing circuitry and has instructions stored therein that are executable by the processing circuitry to cause the communication device to perform operations comprising any of the operations of the first method and/or the second method.

There is also provided a network node operating in a communications network. The network node comprises processing circuitry and a memory. The memory is coupled to the processing circuitry and has instructions stored therein that are executable by the processing circuitry to cause the network node to perform operations comprising any of the operations of the third method and/or the fourth method.

There is also provided a communications network comprising the communication device and the network node.

There is also provided a computer program comprising program code to be executed by processing circuitry, whereby execution of the program code causes the processing circuitry to perform operations comprising any operations of any of the first method, the second method, the third method, and/or the fourth method.

There is also provided a computer program product comprising a non-transitory storage medium including program code to be executed by processing circuitry, whereby execution of the program code causes the processing circuitry to perform operations comprising any operations of any of the first method, the second method, the third method, and/or the fourth method.

There is also provided a non-transitory computer-readable medium having instructions stored therein that are executable by processing circuitry to cause the processing circuitry to perform operations comprising any of the operations of the first method, the second method, the third method, and/or the fourth method.

In operation of a newly introduced MRB with a common PDCP entity, an interesting aspect is how to (re-)initialize PDCP reception variables (e.g. RX_NEXT and RX_DELIV), such as when an MRB is newly configured and in a handover (“HO”) scenario while a UE is in an RRC_CONNECTED state.

There are some agreements related to handling the initiation of PDCP state variables for multicast MRB: 1) For PTM PDCP state variables setting while configured, the sequence number (“SN”) part of COUNT values of these variables are set according to the SN of the first received packet (by the UE) and the hyper frame number (“HFN”) indicated by the gNB, if needed; 2) For multicast MRB, the initial value of the SN part of RX_NEXT is (x+1) modulo (2[PDCP-SN-Size]), where x is the SN of the first received PDCP Data PDU; 3) The initial value of RX_DELIV is set to a value before RX_NEXT, e.g. the initial value of the SN part of RX_DELIV is (x−0.5×2 [PDCP-SN-Size−1]) modulo (2[PDCP-SN-Size]), where x is the SN of the first received PDCP Data PDU; 4) If HFN is needed, the initial value of HFN (maybe+related PDCP SN to avoid ambiguity of HFN) is indicated by the gNB by RRC (e.g. during RRC based MRB bearer type change); and 5) For multicast, the initial value of HFN is indicated by the gNB via RRC.

There currently exist certain challenges. Recent discussions in 3GPP, mainly in RAN2 meetings, result in agreements and changes in specifications regarding (re-)initialization of PDCP reception variables (e.g. RX_NEXT and RX_DELIV), such as when an MRB is newly configured and in a HO scenario. That is, initial values for PDCP variables when a UE setups a new MRB are set according to the SN of the first received PDCP PDU.

In the current RRC running change request (“CR”) (R2-2201829), when a UE enters RRC_INACTIVE, all the radio bearers including MRBs are suspended. Similar to legacy unicast, the suspended MRBs are intended to be used again when the UE enters RRC_CONNECTED. An example of reception of the RRCRelease by the UE is described below.

The UE shall:
1> if the RRCRelease includes suspendConfig:
   2> reset media access control address (“MAC”) and release the default MAC Cell Group configuration, if any;
   2> re-establish RLC entities for signaling radio bearer 1 (“SRB1”);
   2> suspend all SRB(s) and data radio bearer(s) (“DRB(s)”) and multicast MRB(s), except SRB0;
   2> indicate PDCP suspend to lower layers of all DRBs and multicast MRB(s);

At suspension, PDCP state variables (“COUNTs”) are set to initial values, as in the current running PDCP CR (R2-2201729). When upper layers request a PDCP entity is suspended, the transmitting PDCP entity shall: set TX_NEXT to the initial value; and discard all stored PDCP PDUs. When upper layers request a PDCP entity is suspended, the receiving PDCP entity shall: if t-Reordering is running: stop and reset t-Reordering; and deliver all stored PDCP service data units (“SDUs”) to the upper layers in ascending order of associated COUNT values after performing header decompression; otherwise set RX_NEXT and RX_DELIV to the initial value.

The initial values of RX_NEXT and RX_DELIV are 0 in legacy unicast, and set according to the SN of the first received PDCP data PDU in case of MRBs in the current running PDCP CR (R2-2111666), as described below.

For MRBs, the initial value of the SN part of RX_NEXT is (x+1) modulo (2^{[PDCP-SN-Size]}), where x is the SN of the first received PDCP Data PDU.

For MRBs, the initial value of the SN part of RX_DELIV is set to a value before RX_NEXT, e.g. (x−0.5×2^{[PDCP-SN-Size 1]}) modulo (2^{[PDCP-SN-Size]}), where x is the SN of the first received PDCP Data PDU.

However, since the respective multicast MRB is suspended while in RRC_INACTIVE, the first received PDCP data PDU is unknown until after the UE successfully resumes the reception of the multicast sessions, which may or may not happen. Note that resumption of an RRC connection may fail due to different reasons, e.g. radio link failures or unsuccessful UE context transfer. Thus, the current (re-)initialization of RX_NEXT and RX_DELIV at suspension may create ambiguity in a UE PDCP operation, which can be particularly undesirable if the suspension period is long or resumption of the RRC connection is unsuccessful.

In addition, the cause to release the UE to RRC_INACTIVE may or may not be due to the deactivation of the multicast session(s). Note that, it is up to the network to release a UE to RRC_INACTIVE with or without multicast data transmission. An example is when the network experiences a congestion situation due to a large number of RRC_CONNECTED UEs. Another example is when the network wants to update access stratum (“AS”) security of the UE, i.e. nextHopChainingCount update, for some security reason. Similarly, the network may also want to update a RAN notification area (RNA), or the value for a periodic RNA update timer, or a RAN paging cycle, etc. That is, it is possible that the multicast session(s) are being provided while the UE is not in RRC_CONNECTED.

Moreover, in Release 18, RRC_INACTIVE is expected to continue receiving the same multicast session(s) as in RRC_CONNECTED. It remains to be specified what solution will be in Release 18. One of the possible solutions may be developed by not using the same multicast MRB(s) configured for RRC_CONNECTED for RRC_INACTIVE UEs, i.e., multicast MRB(s) are suspended when UE is released to RRC_INACTIVE and then resumed for continuous reception of the multicast data after successful connection resumption.

In all aforementioned cases of release to RRC_INACTIVE, when the RRC_INACTIVE UEs are brought back to RRC_CONNECTED, they may resume/continue receiving the same ongoing multicast session(s) as other RRC_CONNECTED UEs via resumed MRB(s). Among other aspects, the PDCP state variables may be properly re-initialized to ensure continuity in PDCP SN.

In Release 18, there may also be a case where a UE is initially in RRC_CONNECTED, receiving a multicast session via a multicast MRB, but the UE is released to RRC_INACTIVE and continues reception of the same multicast session via a broadcast MRB. In this case, there needs to be some solution for how reception continuity on PDCP layer can be ensured.

It is therefore desired to have a solution to handle the (re-)initialization of PDCP state variables, i.e., RX_NEXT and RX_DELIV for resumed MRB to allow for resumption/continuation of reception of the multicast session when an RRC_INACTIVE UE is moved back to RRC_CONNECTED.

Certain aspects of the disclosure and their embodiments may provide solutions to these or other challenges. Various embodiments herein describe (re-)initialization of PDCP reception operation, i.e., determining how to (re-)initialize state variables RX_NEXT and RX_DELIV for a resumed MRB to allow for resumed/continued reception of the multicast session when an RRC_INACTIVE UE is moved back to RRC_CONNECTED. In addition, embodiments described herein can resolve possible ambiguity in PDCP operation at suspension of a multicast MRB. Moreover, embodiments described herein can enable the UE resuming an RRC connection to receive possible missing multicast data while it was in RRC_INACTIVE for improved reliability.

In some embodiments, a procedure is provided to determine how to set/re-initialize values for PDCP state variables (e.g. RX_NEXT and RX_DELIV) for a resumed multicast MRB to resume or continue reception of multicast services when a UE resumes an RRC connection. At the suspension of an RRC connection, the UE is ensured not to set RX_NEXT and RX_DELIV to an unknown value; the UE is provided with the values of RX_NEXT and RX_DELIV when resuming the RRC connection, or the UE is specified to set the values of RX_NEXT and RX_DELIV according to the first received PDCP data PDU upon resumption of the RRC connection.

In additional or alternative embodiments, a procedure is provided to set/re-initialize values for PDCP state variables of a broadcast MRB, received by a UE following a release from RRC_CONNECTED to RRC_INACTIVE, where the UE has received the same multicast session in RRC_CONNECTED, prior to release.

In additional or alternative embodiments, a procedure is provided to set/re-initialize values for PDCP state variables for a resumed multicast MRB, when the UE returns to RRC_CONNECTED and has received the same multicast session in RRC_INACTIVE via a broadcast MRB.

In additional or alternative embodiments, a procedure is provided to allow a UE resuming an RRC connection to receive possible missing multicast data while it was in RRC_INACTIVE.

Various embodiments enable a UE, transitioning from RRC_INACTIVE to RRC_CONNECTED, to be able to resume the reception of multicast MBS sessions by synchronizing its local PDCP state variables with the PDCP SN used in the network side. Some embodiments also enable a UE, transitioning between (to/from) RRC_INACTIVE and RRC_CONNECTED, using a change of MRB (from a multicast MRB to a broadcast MRB, or from a broadcast MRB to a multicast MRB) to be able to resume the reception of multicast MBS sessions by synchronizing its local PDCP state variables with the PDCP SN used in the network side. In additional or alternative embodiments, the procedure can resolve possible ambiguity in PDCP operation at suspension of a multicast MRB

Certain embodiments may provide one or more of the following technical advantages. Some embodiments may enable a UE transitioning from RRC_INACTIVE to RRC_CONNECTED to be able to resume/continue the reception of multicast MBS sessions by synchronizing its local PDCP state variables with the PDCP SN used in the network side. Additional or alternative embodiments may resolve the possible ambiguity in PDCP operation at suspension of a multicast MRB. Some embodiments may enable the UE to resume an RRC connection to receive possible missing multicast data while it was in RRC_INACTIVE for improved reliability. Additional or alternative embodiments may enable the continuity of reception for cases where the UE is released to RRC_INACTIVE and continues receiving the same multicast session using a broadcast MRB. Additional or alternative embodiments may enable the continuity of reception for cases where the UE comes back to RRC_CONNECTED to resume the multicast MRB after having received the same multicast session in RRC_INACTIVE via a broadcast MRB.

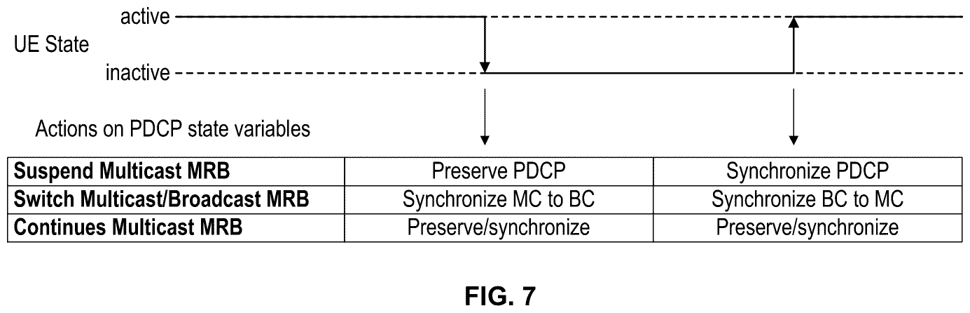

FIG. 7 illustrates an example of operations for handling a multicast radio bearer in response to changes in a state of a communication device in accordance with some embodiments.

In some embodiments, to avoid ambiguity in a packet data convergence protocol (“PDCP”) operation, when upper layers request a PDCP entity is suspended for multicast MRB, the receiving PDCP entity may set RX_NEXT and RX_DELIV to a specific value, for example, zero. Alternatively, at suspension, the receiving PDCP entity of a Multicast Radio Bearer (“MRB”) may not initialize values for RX_NEXT and RX_DELIV.

In additional or alternative embodiments, to ensure service continuity, the network may provide the communication device (also referred to herein as a user equipment (“UE”)) with initial values of RX_NEXT and RX_DELIV for the receiving PDCP entity of a multicast MRB when the UE resumes the radio resource control (“RRC”) connection both at the same serving radio access network (“RAN”) node and a new RAN node, i.e., via an RRCResume message. Thus, the communication device can receive the initial values of RX_NEXT and RX_DELIV from the network. For the synchronization of PDCP COUNT that can be composed of a hyper frame number (“HFN”) and a PDCP sequence number (“SN”), the initial value of HFN may also be indicated in the RRCResume message. In some examples, the network may know which multicast Multicast and Broadcast Services (“MBS”) session(s) the UE is receiving from the stored UE AS context and thus it can provide initial values for the respective PDCP entity. In additional or alternative examples, upon reception of the RRCResume message, the UE RRC sublayer may indicate to the PDCP sublayer to re-initialize the values for RX_NEXT and RX_DELIV accordingly. In additional or alternative examples, the gNB may initialize the PDCP SN in the UE as the SN of the latest transmitted PDCP PDU SN before the UE resumes the RRC connection. If this SN is equal to N−1 and the first transmitted PDCP PDU SN to the UE is N, it may happen that the UE misses one or more (K) of the first transmitted PDCP PDUs. When receiving the first correct PDCP PDU after successful resumption, i.e., with SN N+K, the UE can then detect the SNs of the missing K PDUs and request retransmission of these.

In additional or alternative embodiments, instead of the network providing the initial values for the PDCP RX_NEXT and RX_DELIV, it can be specified that upon successful reception of the RRCResume message from network, the UE RRC sublayer indicates to the PDCP sublayer to set values for RX_NEXT and RX_DELIV according to the sequence number of the first received PDCP PDU. The actual values can be determined in the same way as initialization for newly configured MRB (as specified in current PDCP running CR, R2-2201729). Note that this method works irrespective of whether the multicast session is deactivated or not while the UE is in RRC_INACTIVE.

In additional or alternative embodiments, in case the multicast session is activated while the UE is in RRC_INACTIVE, it can be specified that the UE sets the values for RX_NEXT and RX_DELIV according to SN of the first received PDCP data PDU, similar to the initialization performed for an RRC_CONNECTED UE in case of the first configured multicast MRB.

In additional or alternative embodiments, when the UE resumes the reception of multicast session(s), it may miss a number of PDCP PDUs compared to other UEs which enter RRC_CONNECTED before the UE, or it may stay in RRC_CONNECTED while the UE is in RRC_INACTIVE. For improved reliability, the UE can indicate the last received PDCP PDU to the network for the possible retransmission of missing PDUs. This can be done by the PDCP status reporting for the multicast MRB with acknowledge mode (“AM”) RLC modc. Alternatively, the UE can indicate the SN of the last received PDCP PDU in the uplink RRC message during the resume procedure, i.e., RRCResumeRequest/RRCResumeRequestl or RRCResume Complete.

In additional or alternative embodiments, UEs may receive multicast session(s) while in RRC_INACTIVE e.g., via broadcast MRB(s), for example, as a solution for Release 18 NR_MBS multicast reception in RRC_INACTIVE. In this case, when a UE needs to transition from a multicast MRB to a broadcast MRB, or from a broadcast MRB to a multicast MRB, to continue receiving the same multicast session, the PDCP SNs of the multicast MRB and the broadcast MRB may either be synchronized or unsynchronized. The network may configure the UE with which variant it can assume.

In some examples, when the PDCP SNs of both multicast and broadcast MRBs are synchronized, the network can configure/indicate the UE to expect synchronized PDCP SNs. This allows the UE to use the latest received PDCP PDU, of the first used MRB for re-initialization of the second received MRB. For example, when there is a transition from a broadcast MRB to multicast MRB, i.e., after successful resumption, the latest received PDCP SN of the broadcast MRB may be used to re-initialize the PDCP SN or the multicast MRB. The same can apply for the transition from a multicast MRB to broadcast MRB. In additional or alternative examples, a network can indicate the UE via an indication, e.g., one-bit flag using the unused bits in the RRC message sent to the UE at the transition, for example, in the RRCResume or RRCReconfiguration message.

In additional or alternative examples, when the PDCP SNs of both MRBs are unsynchronized, the network can configure/indicate the UE not to expect synchronized PDCP SNs. The UE can therefore not use the latest PDCP SN of the first MRB to re-initialize the second MRB, as in the synchronized case. Instead, the UE may use the first received PDCP PDU of the second MRB for re-initialization, or the network may provide specific values of the SN to the UE for re-initialization, in the RRC message sent to the UE at the transition, e.g., RRCResume or RRCReconfiguration message.

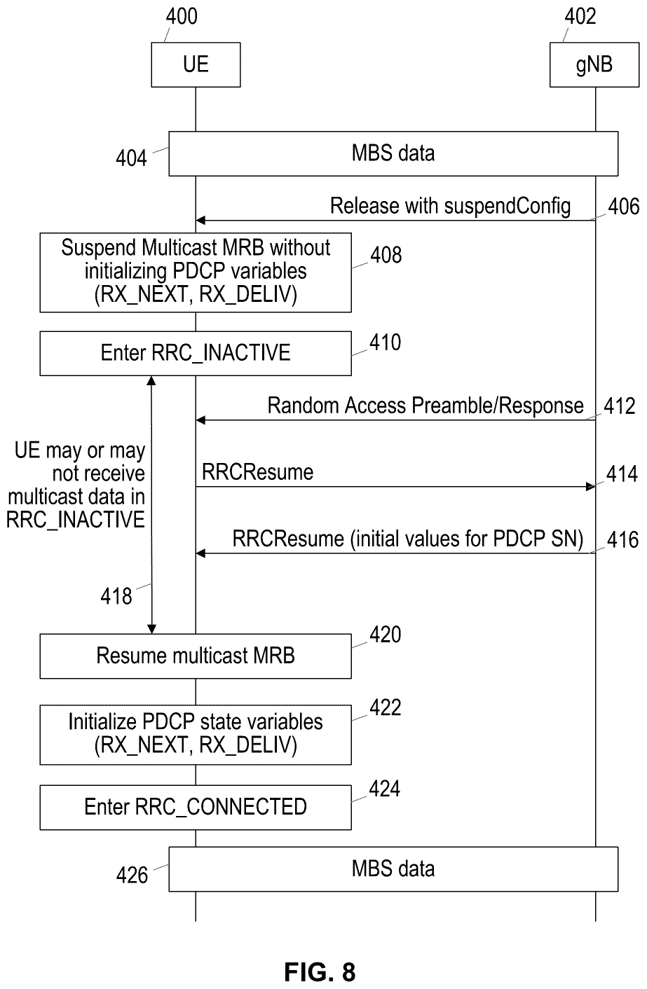

FIG. 8 illustrates an example of a signal flow of operations for handling resumption of NR multicast service reception in accordance with some embodiments. Subsequent to communicating MBS data with a communication device (as illustrated by block 404), a gNB 402 can transmit a release with suspendConfig to a UE 400 (as illustrated by arrow 406). Thus, the UE 400 can receive the release with suspendConfig from the gNB 402. In response to receiving the suspendConfig, the UE 400 can suspend multicast MRB without initializing PDCP variables (e.g., RX_NEXT and RX_DELIV) and enter an RRC_INACTIVE state (as illustrated by blocks 408 and 410 respectively). While the UE 400 is in the RRC_INACTIVE state, the UE 400 may or may not receive multicast data (as illustrated by arrows 418).

The gNB 402 can transmit a random access preamble/response to the UE (as illustrated by arrow 412). Thus, the UE 400 can receive the random access preamble/response from the gNB 402. In response, the UE 400 can transmit an RRCResume to the gNB 402 (as illustrated by arrow 414). Thus, the gNB 402 can receive this RRCResume from the UE 400. The gNB 402 can respond with an RRCResume that includes initial values for the PDCP SN (as illustrated by arrow 416). Thus, the UE 400 can receive this RRCResume from the gNB 402.

The UE 400 can resume the multicast MRB, initialize PDCP state variables (e.g., RX_NEXT and RX_DELIV) and enter an RRC_CONNECTED state (as illustrated by blocks 420, 422 and 424 respectively). While in the RRC_CONNECTED state, the UE 400 can communicate MBS data with the gNB 402 (as illustrated by block 426). For example, the gNB 402 can receive MBS data from the UE 400 and/or the UE 400 can receive MBS data from the gNB 402.

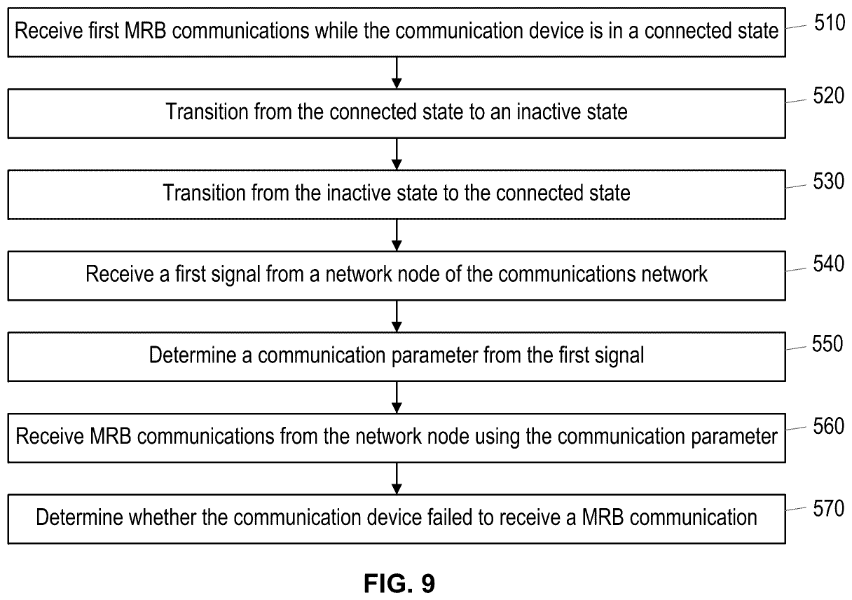

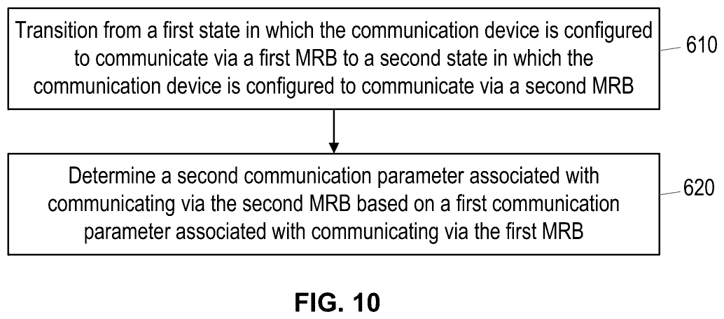

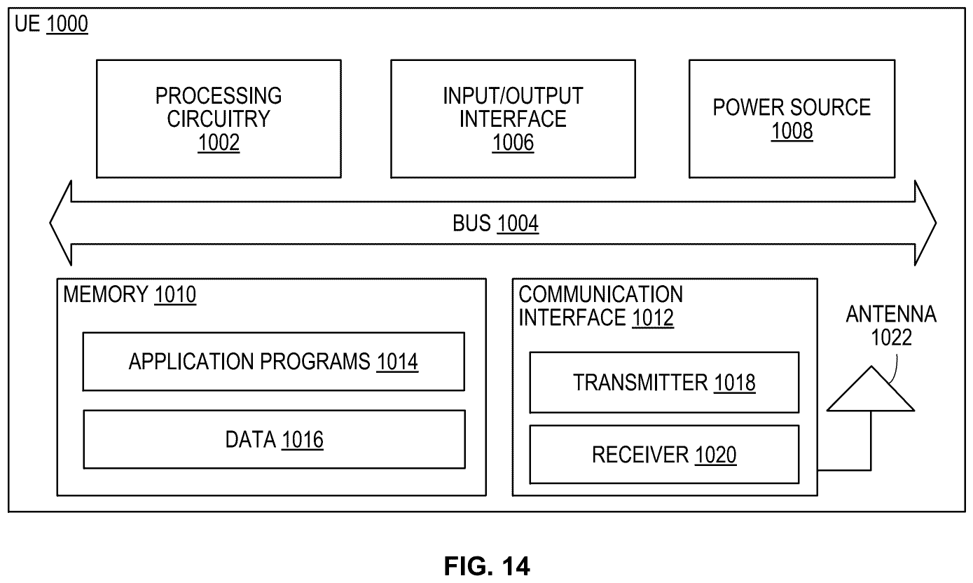

In the description that follows, while the communication device may be any of UE 912A-D, 1000, hardware 1304, or virtual machine 1308A, 1308B, the communication device 1000 shall be used to describe the functionality of the operations of the communication device. Operations of the communication device 1000 (implemented using the structure of FIG. 14) will now be discussed with reference to the flow charts of FIGS. 9-10 according to some embodiments of inventive concepts. For example, modules may be stored in memory 1010 of FIG. 14, and these modules may provide instructions so that when the instructions of a module are executed by respective communication device processing circuitry 1002, processing circuitry 1002 performs respective operations of the flow charts.

FIG. 9 illustrates an example of operations performed by a communication device of a communications network.

At block 510, processing circuitry 1002 may receive, e.g. via communication interface 1012, first MRB communications while the communication device is in a connected state.

At block 520, processing circuitry 1002 may transition from the connected state to an inactive state. In some embodiments, transitioning from the connected state to the inactive state may include initializing a communication parameter to a predetermined value. In additional or alternative embodiments, transitioning from the connected state to the inactive state may include avoiding initialization of the communication parameter.

At block 530, processing circuitry 1002 may transition from the inactive state to the connected state. In some embodiments, this transition may be a return to the connected state after a period of time has elapsed.

In some examples, the inactive state may include an RRC inactive state and the connected state may include an RRC connected state.

At block 540, processing circuitry 1002 receives, e.g. via communication interface 1012, a first signal from a network node of the communications network. In some embodiments, receiving the first signal may include receiving a first PDCP PDU from the network node.

In additional or alternative embodiments, receiving the first signal may include receiving the first signal prior to receiving a first PDCP PDU from the network node. In some examples, receiving the first signal may further include receiving the first signal as part of a procedure performed to transition from the inactive state to the connected state.

At block 550, processing circuitry 1002 determines a communication parameter from the first signal. In some embodiments, the communication parameter may include a PDCP state variable. For example, the PDCP state variable may include at least one of: a first RX_NEXT variable and a first RX_DELIV variable.

At block 560, processing circuitry 1002 receives, e.g. via communication interface 1012, MRB communications from the network node using the communication parameter. In some examples, the MRB communications may include at least one of: multicast MRB communications and broadcast MRB communications.

At block 570, processing circuitry 1002 may determine whether the communication device failed to receive a MRB communication. In some embodiments, determining the communication parameter may include determining an expected sequence number associated with the MRB communications. In some embodiments, receiving the MRB communications may include receiving the first PDCP PDU from the network node. In some embodiments, determining whether the communication device failed to receive the MRB communication can include determining whether the communication device failed to receive a second PDCP PDU from the network node by comparing a sequence number associated with the first PDCP PDU and the expected sequence number.

Various operations of FIG. 9 may be optional with respect to some embodiments. For example, blocks 510, 520, and 570 of FIG. 9 may be optional.

FIG. 10 illustrates an example of operations performed by a communication device of a communications network.

At block 610, processing circuitry 1002 transitions from a first state in which the communication device is configured to communicate via a first MRB to a second state in which the communication device is configured to communicate via a second MRB. In some examples, in the first state, the communication device may be configured to communicate with the network node via a first MRB and in the second state, the communication device may be configured to communicate with the network node via a second MRB that is different than the first MRB. In additional or alternative examples, the first communication parameter may include a first PDCP state variable including at least one of: a first RX_NEXT variable and a first RX_DELIV variable. In additional or alternative examples, the second communication parameter may include a second PDCP state variable including at least one of: a second RX_NEXT variable and a second RX_DELIV variable.

In some embodiments, the first state may include an RRC_connected state, the first MRB may include a multicast MRB, the second state may include an RRC_inactive state, and the second MRB may include a broadcast MRB.

In additional or alternative embodiments, the first state may include an RRC_inactive state, the first MRB may include a broadcast MRB, the second state may include an RRC_connected state, and the second MRB may include a multicast MRB.

At block 620, processing circuitry 1002 determines a second communication parameter associated with communicating via the second MRB based on a first communication parameter associated with communicating via the first MRB. In some embodiments, determining the second communication parameters may include: determining a first sequence number associated with the first MRB; and determining a second sequence number associated with the second MRB based on the first sequence number. In additional or alternative embodiments, determining the second sequence number may include: determining that the network node synchronized the first sequence number and the second sequence number; and determining that the second sequence number is equal to the first sequence number.

In additional or alternative embodiments, determining the second communication parameters may include receiving an indication from the network node of a relationship between the first communication parameter and the second communication parameter. In some examples, receiving the indication may include receiving an indication that the network node synchronized the first sequence number and the second sequence number. In additional or alternative examples, determining the second communication parameter may include determining the second communication parameter based on the first communication parameter in response to receiving the indication from the network node of the relationship between the first communication parameter and the second communication parameter.

Various operations of FIG. 10 may be optional with respect to some embodiments.

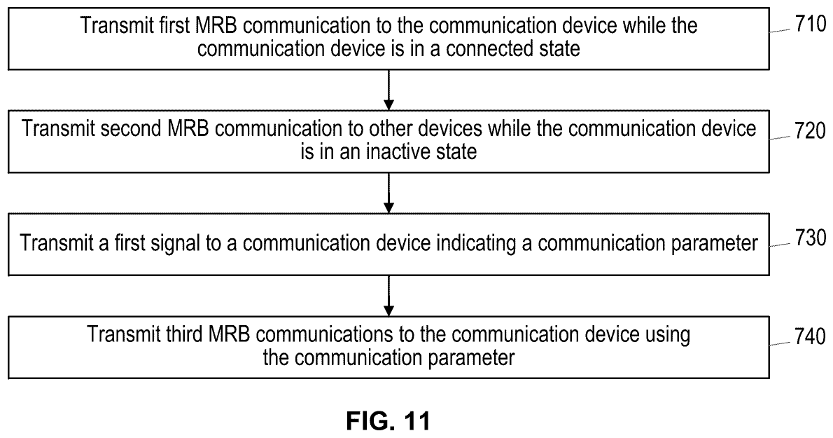

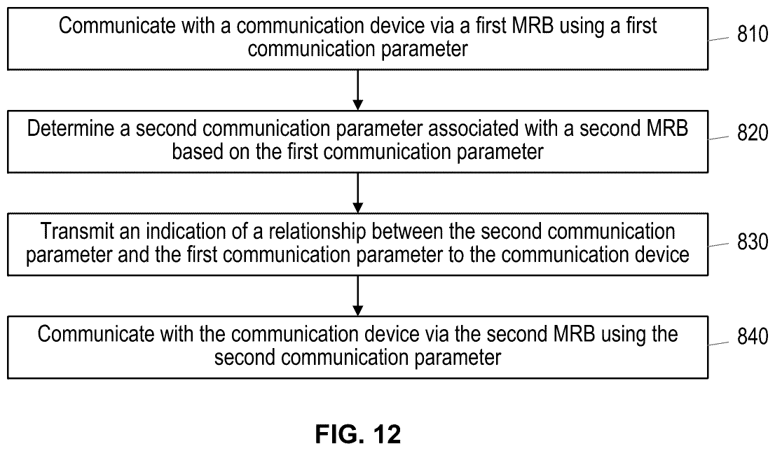

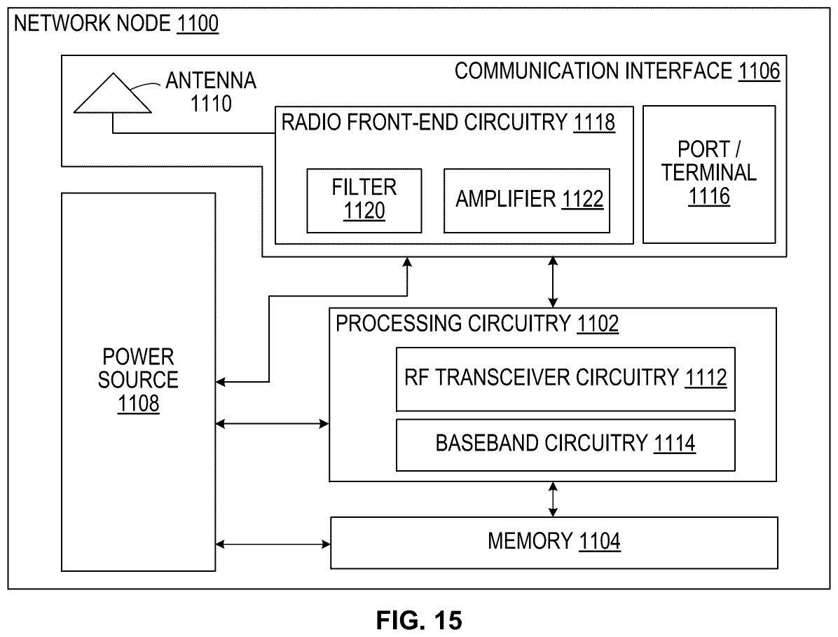

In the description that follows, while the network nodes may be any of the network node 910A, 910B, 1100, 1406, hardware 1304, or virtual machine 1308A, 1308B, the network node 1100 shall be used to describe the functionality of the operations of the network nodes. Operations of the network node 1100 (implemented using the structure of FIG. 15) will now be discussed with reference to the flow charts of FIGS. 11-12 according to some embodiments of inventive concepts. For example, modules may be stored in memory 1104 of FIG. 15, and these modules may provide instructions so that when the instructions of a module are executed by respective network node processing circuitry 1102, processing circuitry 1102 performs respective operations of the flow charts.

FIG. 11 illustrates an example of operations performed by a network node of a communications network.

At block 710, processing circuitry 1102 transmits, e.g. via communication interface 1106, a first MRB communication to a communication device while the communication device is in a connected state. Thus, the communication device can receive the first MRB communication from the network node. In some embodiments, the inactive state may include an RRC_inactive state and the connected state may include an RRC_connected state.

At block 720, processing circuitry 1102 transmits, via communication interface 1106, second MRB communication to other devices while the communication device is in an inactive state. Thus, the other devices can receive the second MRB communication from the network node.

At block 730, processing circuitry 1102 transmits, e.g. via communication interface 1106, a first signal to a communication device indicating a communication parameter. Thus, the communication device can receive the first signal from the network node. In some embodiments, transmitting the first signal may include transmitting a PDCP PDU to the communication device. In additional or alternative embodiments, transmitting the first signal may include transmitting the first signal prior to transmitting a first PDCP PDU to the communication device. In some examples, transmitting the first signal may further include transmitting the first signal as part of a procedure performed to transition the communication device from the inactive state to the connected state.

At block 740, processing circuitry 1102 transmits, e.g. via communication interface 1106, third MRB communications to the communication device using the communication parameter. Thus, the communication device can receive the third MRB communications from the network node. In some embodiments, the MRB communications may include at least one of: multicast MRB communications and broadcast MRB communications.

In additional or alternative embodiments, the communication parameter may include an expected sequence number associated with the MRB communications, and transmitting the MRB communications may include transmitting the first PDCP PDU to the communication device using the expected sequence number.

Various operations of FIG. 11 may be optional with respect to some embodiments. For example, blocks 710 and 720 of FIG. 11 may be optional.

FIG. 12 illustrates an example of operations performed by a network node of a communications network.

At block 810, processing circuitry 1102 communicates, e.g. via communication interface 1106, with a communication device via a first MRB using a first communication parameter.

At block 820, processing circuitry 1102 determines a second communication parameter associated with a second MRB based on the first communication parameter. In some embodiments, determining the second communication parameter may comprise determining the second communication parameter in response to the communication device transitioning from a first state in which the communication device is configured to communicate with a network node of the communications network via the first MRB to a second state in which the communication device is configured to communicate with the network node via a second MRB that is different than the first MRB.

In some examples, the first state may include an RRC connected state, the first MRB may include a multicast MRB, the second state may include an RRC inactive state, and the second MRB may include a broadcast MRB.

In additional or alternative examples, the first state may include an RRC inactive state, the first MRB may include a broadcast MRB, the second state may include an RRC connected state, and the second MRB may include a multicast MRB.

At block 830, processing circuitry 1102 may transmit, e.g. via communication interface 1106, an indication of a relationship between the second communication parameter and the first communication parameter to the communication device. Thus, the communication device can receive the indication from the network node. In some embodiments, the first communication parameter may include a first sequence number, and the second communication parameter may include a second sequence number. In some examples, determining the second communication parameter may include synchronizing the second communication parameter with the first communication parameter.

At block 840, processing circuitry 1102 communicates, e.g. via communication interface 1106, with the communication device via the second MRB using the second communication parameter.

Various operations of FIG. 12 may be optional with respect to some embodiments. For example, blocks 810 and 830 of FIG. 12 may be optional.

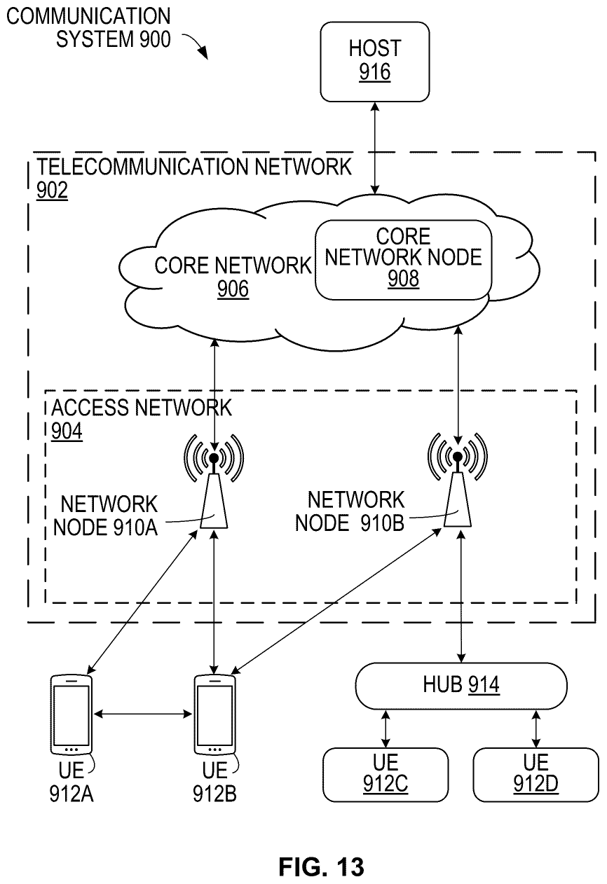

FIG. 13 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC), ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunication network 902 may support network slicing to provide different logical networks to different devices that are connected to the telecommunication network 902. For example, the telecommunication network 902 may provide Ultra Reliable Low Latency Communication (URLLC) services to some UEs, while providing Enhanced Mobile Broadband (cMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to a machine-to-machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 14 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (cMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be, or be configured to include, memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 15 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

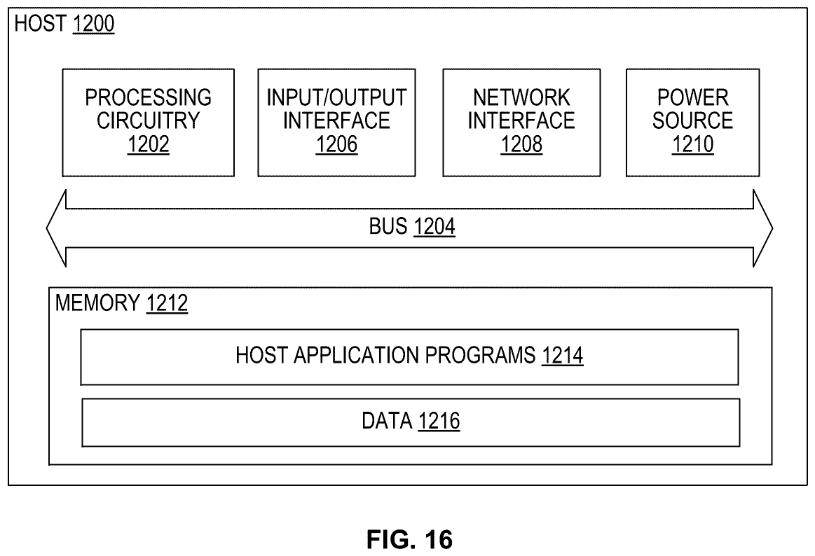

FIG. 16 is a block diagram of a host 1200, which may be an embodiment of the host 916 of FIG. 13, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 14 and 15, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

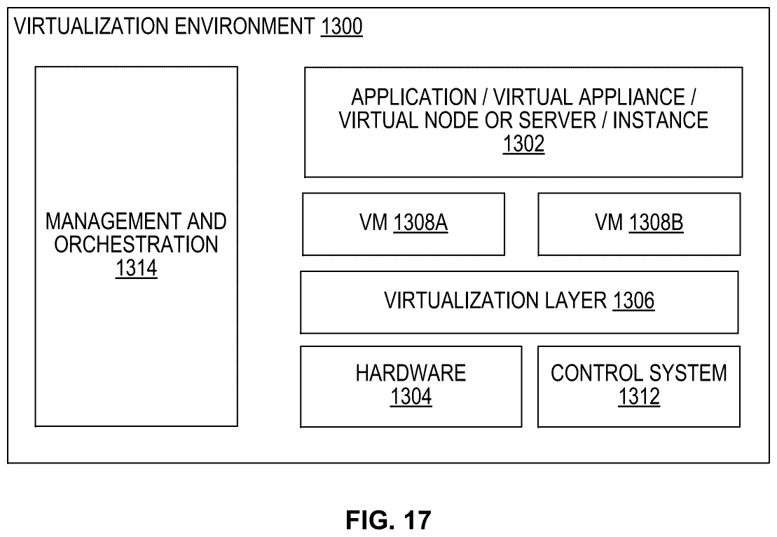

FIG. 17 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

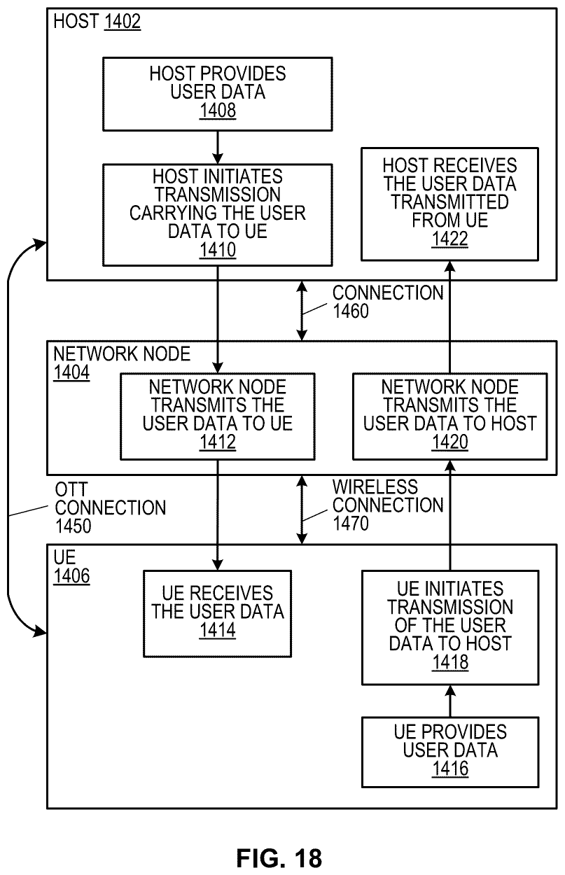

FIG. 18 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 13 and/or UE 1000 of FIG. 14), network node (such as network node 910a of FIG. 13 and/or network node 1100 of FIG. 15), and host (such as host 916 of FIG. 13 and/or host 1200 of FIG. 16) discussed in the preceding paragraphs will now be described with reference to FIG. 18.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 13) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may enable a UE transitioning from RRC_INACTIVE to RRC_CONNECTED to be able to resume/continue the reception of multicast MBS sessions by synchronizing its local PDCP state variables with the PDCP SN used in network side. Additional or alternative embodiments resolve possible ambiguity in PDCP operation at suspension of a multicast MRB. Some embodiments enable the UE to resume an RRC connection to receive possible missing multicast data while it was in RRC_INACTIVE for improved reliability. Additional or alternative embodiments enable continuity of reception for cases where the UE is released to RRC INACTIVE and continues receiving the same multicast session using a broadcast MRB. Additional or alternative embodiments enable continuity of reception for cases where the UE comes back to RRC CONNECTED to resume the multicast MRB after having received the same multicast session in RRC INACTIVE via a broadcast MRB.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

At least some of the following abbreviations may be used in this disclosure. If there is an inconsistency between abbreviations, preference should be given to how it is used above. If listed multiple times below, the first listing should be preferred over any subsequent listing(s).
5G 5th Generation
5GMM 5G Mobility Management
CN Core Network
DCI Downlink Control Indicator
gNB gNodeB
GGAI Geo-Group Area Identifier
LTE Long-Term Evolution
NAS Non-Access Stratum
NR New Radio
NSPS National Security and Public Safety
RAN Radio Access Network
RNA RAN Notification Area
RNTI Radio Network Temporary Identifier
TA Tracking Area
TAI Tracking Area Identifier
UE User Equipment
V2X Vehicle-to-anything communication
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

Other aspects of the present disclosure are defined in the following numbered Statements:
Statement 1. A method of operating a communication device of a communications network, the method comprising:
   transitioning (530) from an inactive state to a connected state;
   receiving (540) a first signal from a network node of the communications network;
   determining (550) a communication parameter from the first signal; and
   receiving (560) multicast radio bearer, MRB, communications from the network node using the communication parameter.
Statement 2. The method of Statement 1, wherein receiving the first signal comprises receiving a first packet data convergence protocol, PDCP, protocol data unit, PDU, from the network node.
Statement 3. The method of Statement 1, wherein receiving the first signal comprises receiving the first signal prior to receiving a first packet data convergence protocol, PDCP, protocol data unit, PDU from the network node.
Statement 4. The method of Statement 3, wherein receiving the first signal further comprises receiving the first signal as part of a procedure performed to transition from the inactive state to the connected state.
Statement 5. The method of any of Statements 3-4, wherein determining the communication parameter comprises determining an expected sequence number associated with the MRB communications, and
   wherein receiving the MRB communications comprises receiving the first PDCP PDU from the network node,
   the method further comprising:
      determining (570) whether the communication device failed to receive a second PDCP PDU from the network node by comparing a sequence number associated with the first PDCP PDU and the expected sequence number.
Statement 6. The method of any of Statements 1-5, wherein the MRB communications are second MRB communications,
   wherein the connected state is a second instance of the connected state,
   the method further comprising:
      receiving (510) first MRB communications from the network node while the communication device is in a first instance of the connected state; and
      subsequent to receiving the first MRB communications, transitioning (520) from the first instance of the connected state to the inactive state.
Statement 7. The method of Statement 6, wherein transitioning from the first instance of the connected state to the inactive state comprises:
   initializing the communication parameter to a predetermined value.
Statement 8. The method of Statement 6, wherein transitioning from the first instance of the connected state to the inactive state comprises:
   avoiding initialization of the communication parameter.
Statement 9. The method of any of Statements 1-8, wherein the communication parameter comprises a packet data convergence protocol, PDCP, state variable including at least one of: a first RX_NEXT variable and a first RX_DELIV variable.
Statement 10. The method of any of Statements 1-9, wherein the inactive state comprises a radio resource control, RRC, inactive state,
   wherein the connected state comprises a RRC connected state, and
   wherein the MRB communications comprise at least one of: multicast MRB communications and broadcast MRB communications.
Statement 11. A method of operating a communication device of a communications network, the method comprising:
   transitioning (610) from a first state in which the communication device is configured to communicate with a network node of the communications network via a first multicast radio bearer, MRB, to a second state in which the communication device is configured to communicate with the network node via a second MRB that is different than the first MRB; and
   determining (620) a second communication parameter associated with communicating with the network node via the second MRB based on a first communication parameter associated with communicating with the network node via the first MRB.
Statement 12. The method of Statement 11, wherein the first state comprises a radio resource control, RRC, connected state,
   wherein the first MRB comprises a multicast MRB,
   wherein the second state comprises a RRC inactive state, and
   wherein the second MRB comprises a broadcast MRB.
Statement 13. The method of Statement 11, wherein the first state comprises a radio resource control, RRC, inactive state,
   wherein the first MRB comprises a broadcast MRB,
   wherein the second state comprises a RRC connected state, and
   wherein the second MRB comprises a multicast MRB.
Statement 14. The method of any of Statements 11-13, wherein determining the second communication parameters comprises:
   determining a first sequence number associated with the first MRB; and
   determining a second sequence number associated with the second MRB based on the first sequence number.
Statement 15. The method of Statement 14, wherein determining the second sequence number comprises:
   determining that the network node synchronized the first sequence number and the second sequence number; and
   determining that the second sequence number is equal to the first sequence number.
Statement 16. The method of any of Statements 11-15, wherein determining the second communication parameters comprises:
   receiving an indication from the network node of a relationship between the first communication parameter and the second communication parameter.
Statement 17. The method of Statement 16, wherein receiving the indication comprises receiving an indication that the network node synchronized the first sequence number and the second sequence number.
Statement 18. The method of any of Statements 16-17, wherein determining the second communication parameter comprises:
   determining the second communication parameter based on the first communication parameter in response to receiving the indication from the network node of the relationship between the first communication parameter and the second communication parameter.
Statement 19. The method of any of Statements 11-18, wherein the first communication parameter comprises a first packet data convergence protocol, PDCP, state variable including at least one of: a first RX_NEXT variable and a first RX_DELIV variable, and
   wherein the second communication parameter comprises a second PDCP state variable including at least one of: a second RX_NEXT variable and a second RX_DELIV variable.
Statement 20. The method of any of Statements 11-19, further comprising any of the operations of Statements 1-9.
Statement 21. A method of operating a network node of a communications network, the method comprising:
   responsive to a communication device transitioning from an inactive state to a connected state, transmitting (730) a first signal to the communication device indicating a communication parameter; and
   transmitting (740) multicast radio bearer, MRB, communications to the communication device using the communication parameter.
Statement 22. The method of Statement 21, wherein transmitting the first signal comprises transmitting a first packet data convergence protocol, PDCP, protocol data unit, PDU to the communication device.
Statement 23. The method of Statement 21, wherein transmitting the first signal comprises transmitting the first signal prior to transmitting a first packet data convergence protocol, PDCP, protocol data unit, PDU, to the communication device.
Statement 24. The method of Statement 23, wherein transmitting the first signal further comprises transmitting the first signal as part of a procedure performed to transition the communication device from the inactive state to the connected state.
Statement 25. The method of any of Statements 23-24, wherein the communication parameter comprises an expected sequence number associated with the MRB communications, and
   wherein transmitting the MRB communications comprises transmitting the first PDCP PDU to the communication device using the expected sequence number.
Statement 26. The method of any of Statements 21-25, wherein the MRB communications are third MRB communications,
   wherein the connected state is a second instance of the connected state,
   the method further comprising:
      transmitting (710) first MRB communications to the communication device while the communication device is in a first instance of the connected state; and
      transmitting (720) second MRB communications to other devices while the communication device is in the inactive state.
Statement 27. The method of any of Statements 21-26, wherein the inactive state comprises a radio resource control, RRC, inactive state,
   wherein the connected state comprises a RRC connected state, and
   wherein the MRB communications comprise at least one of: multicast MRB communications and broadcast MRB communications.
Statement 28. A method of operating a network node of a communications network, the method comprising:
   responsive to a communication device transitioning from a first state in which the communication device is configured to communicate with a network node of the communications network via a first multicast radio bearer, MRB, to a second state in which the communication device is configured to communicate with the network node via a second MRB that is different than the first MRB, determining (820) a second communication parameter associated with the second MRB based on a first communication parameter associated with the first MRB; and
   communicating (840) with the communication device via the second MRB using the second communication parameter.
Statement 29. The method of Statement 28, wherein the first state comprises a radio resource control, RRC, connected state,
   wherein the first MRB comprises a multicast MRB,
   wherein the second state comprises a RRC inactive state, and
   wherein the second MRB comprises a broadcast MRB.
Statement 30. The method of Statement 28, wherein the first state comprises a radio resource control, RRC, inactive state,
   wherein the first MRB comprises a broadcast MRB,
   wherein the second state comprises a RRC connected state, and
   wherein the second MRB comprises a multicast MRB.
Statement 31. The method of any of Statements 28-30, wherein the first communication parameter comprises a first sequence number, and
   wherein the second communication parameter comprises a second sequence number.
Statement 32. The method of any of Statements 28-31, wherein determining the second communication parameter comprises synchronizing the second communication parameter with the first communication parameter.
Statement 33. The method of any of Statements 28-32, further comprising:
   transmitting (830) an indication of a relationship between the second communication parameter and the first communication parameter to the communication device.
Statement 34. The method of any of Statements 28-33, further comprising:
   prior to the communication device transitioning from the first state to the second state, communicating (810) with the communication device via the first MRB using the first communication parameter.
Statement 35. The method of any of Statements 28-34, further comprising any of the operations of Statements 21-27.
Statement 36. A communication device (912A-D, 1000, 1304) operating in a communications network, the communication device comprising:
   processing circuitry (1002); and
   memory (1010) coupled to the processing circuitry and having instructions stored therein that are executable by the processing circuitry to cause the communication device to perform operations comprising any of the operations of Statements 1-20.
Statement 37. A computer program comprising program code to be executed by processing circuitry (1002) of a communication device (912A-D, 1000, 1304) operating in a communications network, whereby execution of the program code causes the communication device to perform operations comprising any operations of Statements 1-20.
Statement 38. A computer program product comprising a non-transitory storage medium (1010) including program code to be executed by processing circuitry (1002) of a communication device (912A-D, 1000, 1304) operating in a communications network, whereby execution of the program code causes the communication device to perform operations comprising any operations of Statements 1-20.
Statement 39. A non-transitory computer-readable medium having instructions stored therein that are executable by processing circuitry (1002) of a communication device (912A-D, 1000, 1304) operating in a communications network to cause the communication device to perform operations comprising any of the operations of Statements 1-20.
Statement 40. A network node (908, 910A, 910B, 1100, 1406, 1304, 1308A, 1308B) operating in a communications network, the network node comprising:
   processing circuitry (1102); and
   memory (1104) coupled to the processing circuitry and having instructions stored therein that are executable by the processing circuitry to cause the network node to perform operations comprising any of the operations of Statements 21-35.
Statement 41. A computer program comprising program code to be executed by processing circuitry (1102) of a network node (908, 910A, 910B, 1100, 1406, 1304, 1308A, 1308B) operating in a communications network, whereby execution of the program code causes the network node to perform operations comprising any operations of Statements 21-35.
Statement 42. A computer program product comprising a non-transitory storage medium (1104) including program code to be executed by processing circuitry (1102) of a network node (908, 910A, 910B, 1100, 1406, 1304, 1308A, 1308B) operating in a communications network, whereby execution of the program code causes the network node to perform operations comprising any operations of Statements 21-35.
Statement 43. A non-transitory computer-readable medium having instructions stored therein that are executable by processing circuitry (1102) of a network node (908, 910A, 910B, 1100, 1406, 1304, 1308A, 1308B) operating in a communications network to cause the network node to perform operations comprising any of the operations of Statements 21-35.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on (or in) memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of operating a user equipment, UE, of a communications network, the method comprising:
receiving a first signal from a network node of the communications network;
determining a first communication parameter from the first signal; and
receiving multicast radio bearer, MRB, communications from the network node using the first communication parameter via a first MRB.

2. The method of claim 1, wherein receiving the first signal comprises receiving a first packet data convergence protocol, PDCP, protocol data unit, PDU, from the network node.

3. The method of claim 1, wherein receiving the first signal comprises receiving the first signal prior to receiving a first packet data convergence protocol, PDCP, protocol data unit, PDU from the network node.

4. The method of claim 3, wherein receiving the first signal further comprises receiving the first signal as part of a procedure performed to transition the UE from an inactive state to a connected state.

5. The method of claim 3, wherein determining the first communication parameter comprises determining an expected sequence number associated with the MRB communications, and
wherein receiving the MRB communications comprises receiving the first PDCP PDU from the network node,
the method further comprising:
determining whether the UE failed to receive a second PDCP PDU from the network node by comparing a sequence number associated with the first PDCP PDU and the expected sequence number.

6. The method of claim 1, wherein the method comprises:
transitioning from an inactive state to a connected state.

7. The method of claim 6, wherein:
the MRB communications are second MRB communications;
transitioning from an inactive state to a connected state comprises transitioning from an inactive state to a second instance of a connected state; and
the method further comprises:
receiving first MRB communications from the network node while the UE is in a first instance of the connected state; and
subsequent to receiving the first MRB communications, transitioning from the first instance of the connected state to the inactive state.

8. The method of claim 7, wherein transitioning from the first instance of the connected state to the inactive state comprises:
initializing the first communication parameter to a predetermined value; or
avoiding initialization of the first communication parameter.

9. The method of claim 6, wherein the inactive state comprises a radio resource control, RRC, inactive state,
wherein the connected state comprises an RRC connected state, and
wherein the MRB communications comprise at least one of: multicast MRB communications and broadcast MRB communications.

10. The method of claim 1, wherein the first communication parameter comprises a packet data convergence protocol, PDCP, state variable including at least one of: a first RX_NEXT variable and a first RX_DELIV variable.

11. A The method of claim 1, further comprising:
transitioning from a first state in which the UE is configured to communicate with the network node via the first MRB to a second state in which the UE is configured to communicate with the network node via a second MRB that is different than the first MRB; and
determining a second communication parameter associated with communicating with the network node via the second MRB based on the first communication parameter.

12. (canceled)

13. The method of claim 11, wherein determining the second communication parameters comprises:
determining a first sequence number associated with the first MRB; and
determining a second sequence number associated with the second MRB based on the first sequence number.

14-18. (canceled)

19. A method of operating a network node of a communications network, the method comprising:
transmitting a first signal to a user equipment, UE, indicating a first communication parameter; and
transmitting multicast radio bearer, MRB, communications to the UE using the first communication parameter via a first MRB.

20-23. (canceled)

24. The method of claim 19, wherein transmitting the first signal to the UE is performed responsive to the UE transitioning from an inactive state to a connected state.

25. The method of claim 24, wherein:
the MRB communications are third MRB communications;
transitioning from an inactive state to a connected state comprises transitioning from an active state to a second instance of a connected state; and
the method further comprises:
transmitting first MRB communications to the UE while the UE is in a first instance of the connected state; and
transmitting second MRB communications to other devices while the UE is in the inactive state.

26. The method of claim 24, wherein the inactive state comprises a radio resource control, RRC, inactive state,
wherein the connected state comprises an RRC connected state, and
wherein the MRB communications comprise at least one of: multicast MRB communications and broadcast MRB communications.

27. The method of claim 19, further comprising:
responsive to the UE transitioning from a first state in which the UE is configured to communicate with the network node via the first MRB to a second state in which the UE is configured to communicate with the network node via a second MRB that is different than the first MRB, determining a second communication parameter associated with the second MRB based on the first communication parameter; and
communicating with the UE via the second MRB using the second communication parameter.

28-32. (canceled)

33. A user equipment, UE, operating in a communications network, the UE comprising:
processing circuitry; and
a memory coupled to the processing circuitry and having instructions stored therein that are executable by the processing circuitry to cause the UE to perform operations comprising:
receiving a first signal from a network node of the communications network;
determining a first communication parameter from the first signal; and
receiving multicast radio bearer, MRB, communications from the network node using the first communication parameter via a first MRB.

34. (canceled)

35. A non-transitory computer-readable storage medium comprising program code to be executed by processing circuitry, whereby execution of the program code causes the processing circuitry to perform the method of claim 1.

36. A non-transitory computer-readable storage medium including program code to be executed by processing circuitry, whereby execution of the program code causes the processing circuitry to perform the method of claim 19.
